(19) United States
(12) Patent Application Publication
(10) Pub. No.: US 2024/0232651 A9
(43) Pub. Date: Jul. 11, 2024

(54) SIMULATING TRAINING DATA FOR MACHINE LEARNING MODELING AND ANALYSIS

(71) Applicant: DIMAAG-AI, Inc., Fremont, CA (US)

(72) Inventors: Rajaram Kudli, Bengaluru (IN); Satish Padmanabhan, Sunnyvale, CA (US); Fuk Ho Pius Ng, Portland, OR (US); Nagarjun Pogakula Surya Prakash, Bangalore (IN); Ananda Shekappa Sonnada, Bangalore (IN)

(73) Assignee: DIMAAG-AI, Inc., Fremont, CA (US)

(21) Appl. No.: 18/047,841

(22) Filed: Oct. 19, 2022

(51) Int. Cl. G06N 5/02

(52) U.S. Cl. CPC G06N 5/022

(57) ABSTRACT

One or more structural equations modeling a physical process over time may be sampled using simulated parameter values to generate input data signal values. A noise generator may be applied to the input data signal values to generate noise values. The noise values and the input data signal values may be combined to determined noisy data signal values. These noisy data signal values may in turn be used in combination with one or more states to train a prediction model.

### FIELD OF TECHNOLOGY

This patent document relates generally to machine learning analysis and more specifically to the generation of simulated training data in machine learning analysis.

### BACKGROUND

Supervised machine learning analysis involves training a model using training data. The trained model may then be deployed to a production environment. For example, data characterizing the operation and occasional failure of machines may be used to train a model to identify machine failure. The trained model may then be deployed in a production environment such as a mechanical shop to predict machine failures before they occur.

Efficacies of the supervised learning paradigms of such predictive models are constrained by the availability of training data. That is, the predictive performance of a model is limited by the amount of training data available to pre-train the prediction model before it is applied to test data. For example, rich training data may be unavailable until after an application is deployed, but application deployment may in turn depend on a prediction model that cannot be sufficiently trained due to limitations in the availability of training data. Given the importance of predictive models across a range of industrial and non-industrial applications, improved techniques for training and deploying prediction models are desired.

### Overview

Systems, apparatus, methods and computer program products described herein facilitate the generation of simulated training data in machine learning analysis. According to various embodiments, a plurality of input data signal values may be determined by sampling from a designated structural equation at a designated sampling frequency. The designated structural equation may model a physical process over time and may be associated with one or more states of a plurality of states. A plurality of noise values may be determined by applying a noise generator to the input data signal values based on a designated noise level. A plurality of noisy data signal values may be determined by combining the plurality of input data signal values with the plurality of noise values. A prediction model may be determined based on a plurality of training data observations determined based on the noisy data signal values and the one or more states. The prediction model may be trained to predict a test data observation as belonging to a predicted state of the plurality of state. The prediction model may be stored on a storage device.

According to various embodiments, the designated structural equation may be one of a plurality of structural equations. The plurality of input data signal values may be determined by sampling from the plurality of structural equations.

In some embodiments, input data for the designated structural equation may be determined. The input data may include one or more parameter values corresponding with parameters in the designated structural equation. A designated one of the parameter values may correspond to a physical characteristic of a mechanical machine associated with the physical process.

In some embodiments, the physical process may include operation of a mechanical bearing type. The plurality of states may include a designated state corresponding with a failure mode associated with the mechanical bearing type. The test data observation may include a feature vector including a plurality of values corresponding with the plurality of input data signal values.

In some implementations, a predicted target value may be determined by applying the prediction model to the test data observation. A designated feature data segment of a plurality of feature data segments may be determined by applying a feature segmentation model to a test data observation. The feature segmentation model may be pre-trained via the noisy data signal values and the one or more states. The feature segmentation model may divide the plurality of training data observations into the plurality of feature data segments. A feature novelty value may be determined based at least in part on the predicted target value and the test data observation. The feature novelty value may indicate a degree to which the test data observation is represented in the training data observations.

According to various embodiments, the test data observation may include a case attribute vector that in turn includes one or more metadata values characterizing the test data observation. A designated case attribute data segment of a plurality of case attribute data segments may be determined by applying a case attribute segmentation model to the case attribute vector via the processor. The case attribute segmentation model may be pre-trained via the plurality of training data observations and may divide the plurality of training data observations into the plurality of case attribute data segments.

### BRIEF DESCRIPTION OF THE DRAWINGS

The included drawings are for illustrative purposes and serve only to provide examples of possible structures and operations for the disclosed inventive systems, apparatus, methods and computer program products for the detection of novel data in machine learning analysis. These drawings in no way limit any changes in form and detail that may be made by one skilled in the art without departing from the spirit and scope of the disclosed implementations.

FIG. 1 illustrates an example of an overview method for novel data detection, performed in accordance with one or more embodiments.

FIG. 2 illustrates an example of a method for training data generation, performed in accordance with one or more embodiments.

FIG. 3 illustrates an example of a method for determining a supervised machine learning prediction model, performed in accordance with one or more embodiments.

FIG. 4 illustrates an example of a method for determining an unsupervised machine learning segmentation model, performed in accordance with one or more embodiments.

FIG. 5 illustrates an example of a method for applying supervised and unsupervised models, performed in accordance with one or more embodiments.

FIG. 6 illustrates one example of a computing device, configured in accordance with one or more embodiments.

### DETAILED DESCRIPTION

Techniques and mechanisms described herein provide for automated processes for generating simulated training data. Structural equations are available for modeling many common physical processes, such as the performance and failure of mechanical bearings. Signal data may be generated from such structural equations by applying simulated parameter values to the structural equations. The signal data may be used to generate noise values to model the natural noise inherent in physical processes. The noise values may be combined with the signal data to generate noisy signal. The noisy signal data may then in turn be combined with state data associated with the structural equations. For instance, the state data may indicate a particular failure mode for a physical process modeled by a particular structural equation under particular conditions. The noisy signal data may then be used to train a prediction model for predicting states associated with the physical process.

Techniques and mechanisms described herein also provide automated processes for integrating supervised and unsupervised classification results of a test data observation with training data observations in a feature space. Novelty of the test data observation relative to the feature space may be measured using a distance metric. For instance, a distance of a test case from the centers of stable segments of the training dataset in the feature space may be determined. Alternatively, or additionally, the distribution of the within-segment distances of the feature-vectors in the nearest segment may be determined. Such analysis may facilitate an automated, generalized inference rule-base for labeling the novelty of a test data observation. For instance, a test data observation may be labeled as well-represented, under-represented, or mis-represented in the training data. A rule-based recommendation engine may be used to facilitate incremental or batched self-healing with novel data.

Prediction models are limited in efficacy by the data used in their construction. For example, consider a prediction model trained to predict the failure of bearings in mechanical machines. In such a context, failure indicators such as noise and smoke may occur only immediately before the failure event, while failure indicators such as changes in heat and pressure may occur further in advance. However, the earliest indicator of incipient failure may be vibration detected vibration sensors. Nevertheless, the use of vibration data to predict machine failure may be limited by the availability of vibration data associated with failure conditions.

Keeping with the example of using vibration data to predict bearing failure, such failures may be divided into various categories, such as failures in the inner race, outer race, and balls, with different failure modes being associated with different types of vibration patterns. Moreover, vibration patterns may vary based on machine type, machine context, ambient temperature, ambient pressure, ambient vibration, and/or any of a variety of other characteristics. Thus, when using conventional techniques, static training data may fail to encompass many of the large variety of conditions under which vibrations may indicate incipient failure.

Compounding the problem, limited sources of training data exist for many contexts in which a prediction model is desired. Generating training data empirically in a laboratory setting is often prohibitively expensive. Making matters worse, generating training data in a laboratory setting that comprehensively covers the range of possible failure conditions that may occur in real-world contexts such as idiosyncratic machine shops may be effectively impossible. For these and other reasons, conventional techniques fail to provide a way to generate a pre-trained prediction model for purposes such as using vibration to predict bearing failure in diverse real-world contexts.

The difficulty in using conventional techniques to generate a pre-trained model leads to a sort of “chicken and egg” problem. Data from real-world contexts may be collected from sensor units deployed to machines operating in real-world contexts. However, such sensors typically need to be deployed with a pre-trained prediction model, which as discussed above is often difficult to create using conventional techniques in the absence of real-world training data.

Techniques and mechanisms described herein provide for the generation of supervised machine learning prediction models even in the absence of real-world training data. Such a trained supervised machine learning prediction model can then be deployed in real-world contexts such as machine shops. After deployment, the trained supervised machine learning prediction model can be used to predict failure events. At the same time, an unsupervised machine learning segmentation model may be used in conjunction with the supervised machine learning prediction model to classify newly observed test data based on its novelty relative to the training data. The novelty classification may then be used to formulate a response to the test data.

For the purpose of exposition, various techniques are described herein with reference to a particular example of a machine learning prediction problem in which machine vibration data is used to predict bearing failure. However, various embodiments of techniques and mechanisms described herein are broadly applicable to a range of contexts. For example, techniques and mechanisms described herein may be used to predict machine failure in a variety of contexts based on a variety of input data, such as data from various sensors of various types associated with mechanical machines or machine components. As another example, techniques and mechanisms described herein may be used to predict any type of outcome for which production data observed in deployment may at least occasionally differ considerably from patterns observable in data used to train the machine learning prediction model.

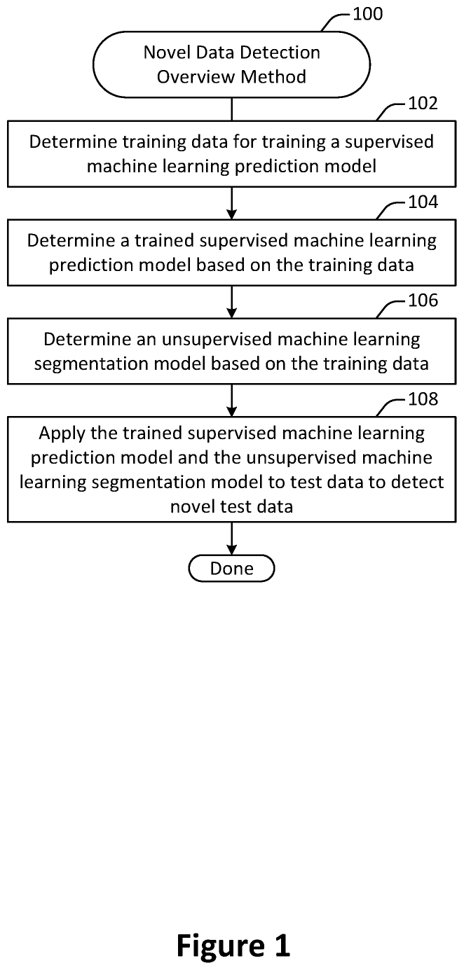

FIG. 1 illustrates an example of an overview method 100 for novel data detection, performed in accordance with one or more embodiments. According to various embodiments, the method 100 may be performed on any suitable computing device or devices.

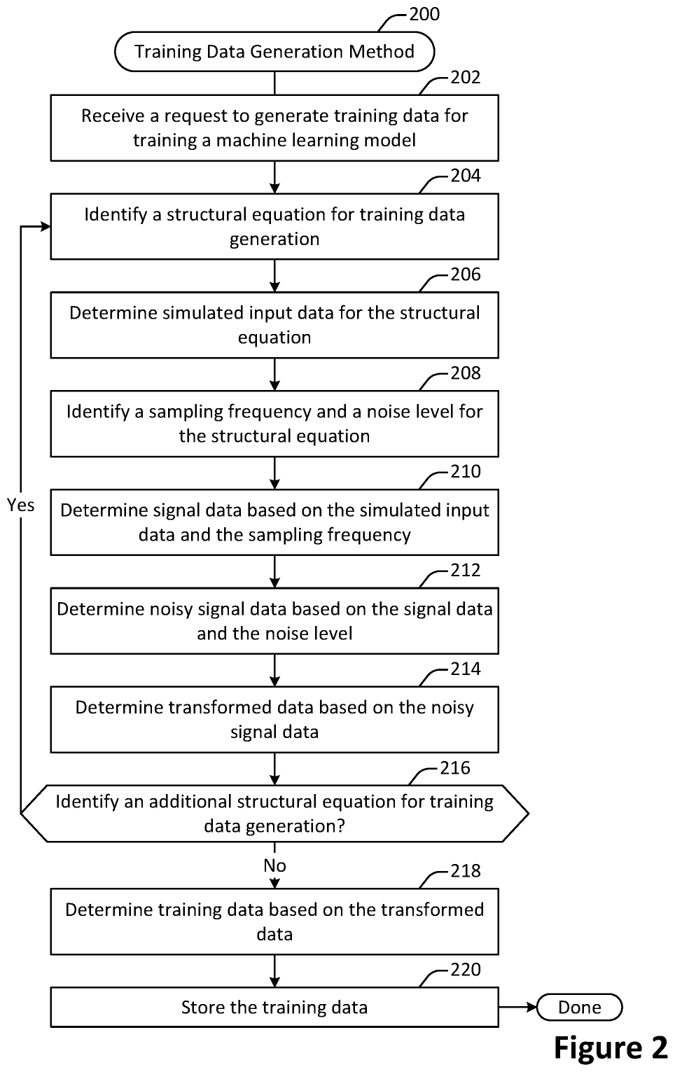

Training data for training a supervised machine learning prediction model is determined at 102. In some embodiments, training data for training a supervised machine learning prediction model may be, at least in part, pre-determined or provided via conventional techniques. Alternatively, or additionally, training data for training a supervised machine learning prediction model may be, at least in part, generated using a simulation process. In such a process, one or more structural equations may be used to generate data that may then be used to train a model. Additional details regarding such a process are discussed with respect to the method 200 shown in FIG. 2.

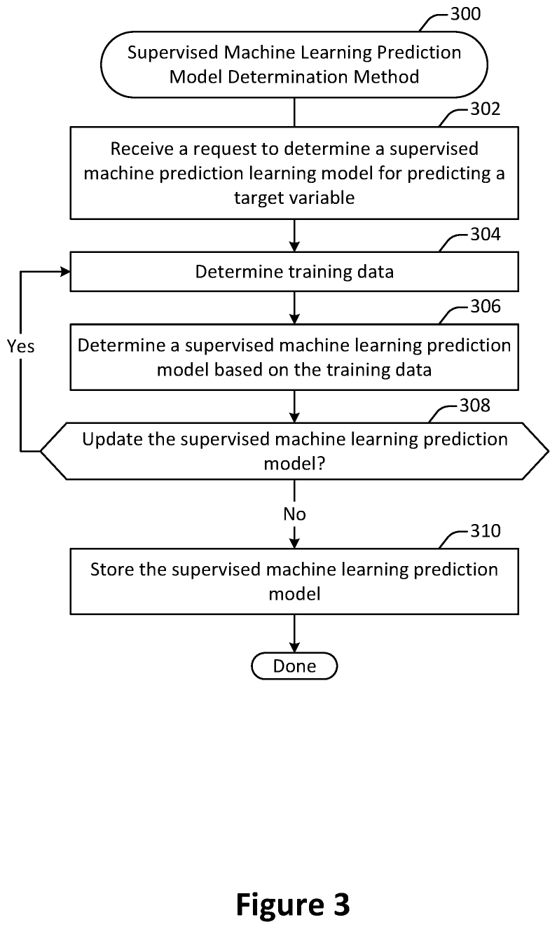

A trained supervised machine learning prediction model is determined at 104 based on the training data. According to various embodiments, determining the trained supervised machine learning prediction model may involve operations such as dividing training data into modeling and validation components, implementing one or more model training and validation phases, and repeating such operations as desired. Additional details regarding the determination of a trained supervised machine learning prediction model are discussed with respect to the method 300 shown in FIG. 3.

An unsupervised machine learning segmentation model is determined at 106 based on the training data. According to various embodiments, determining the unsupervised machine learning segmentation model may involve operations such as dividing the training data into segments, determining definitions for the segments for applying to test data, and/or determining statistical profiles for the segments for use in statistical analysis of test data.

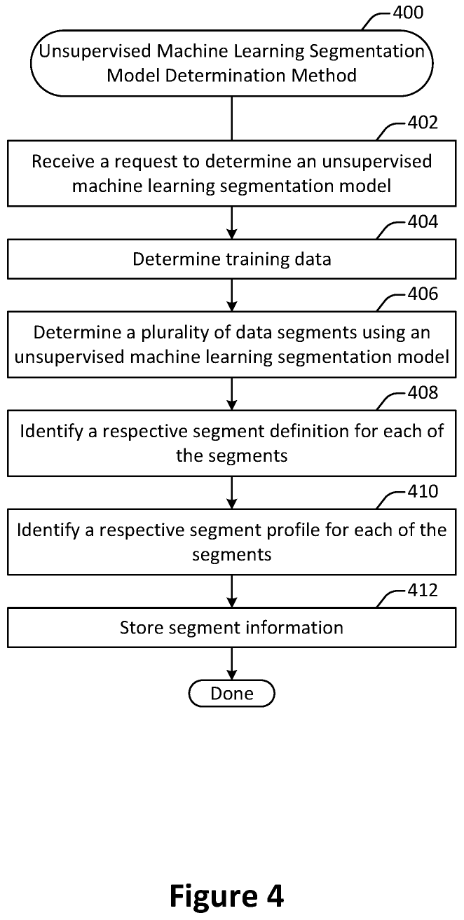

Additional details regarding the determination of an unsupervised machine learning segmentation model are discussed with respect to the method 400 shown in FIG. 4.

According to various embodiments, training data observations may include feature vectors and/or case attributes. Feature vectors may include values about a particular observation that correspond to particular features. Case attributes may include metadata about an observation, such as characteristics of a machine that generated a data associated with a particular feature vector. Case attributes and feature vectors may be treated separately in some configurations. Alternatively, or additionally, some or all of the case attribute values may be included in the corresponding feature vectors.

In some embodiments, a single segmentation model may be constructed, which may for instance correspond to the feature vectors. Alternatively, in some configurations more than one segmentation model may be constructed. For instance, different segmentation models may be constructed for feature vectors and case attributes.

The trained supervised machine learning prediction model and the unsupervised machine learning segmentation model are applied to test data at 108 to detect novel test data. When test data is consistent with data observed in the training phase, the prediction produced by the trained supervised machine learning prediction model may be employed. When instead test data is inconsistent with data observed in the training phase, the test data may be used to update the trained supervised machine learning prediction model.

In some embodiments, novelty detection for a test data observation may involve the application of more than one unsupervised machine learning segmentation models. For example, one model may be employed to evaluate novelty for a feature vector, while another model may be employed to evaluate novelty for a vector of case attributes.

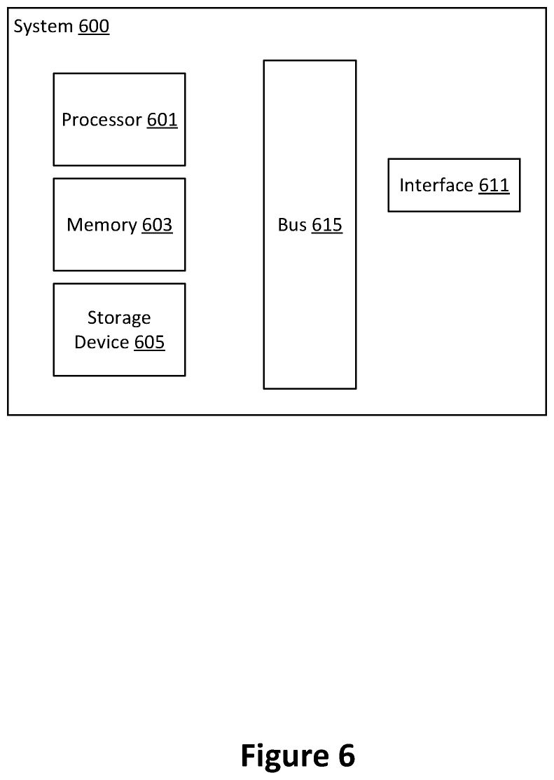

FIG. 2 illustrates an example of a method 200 for training data generation, performed in accordance with one or more embodiments. According to various embodiments, the method 200 may be performed on any suitable computing device, such as the system 600 discussed with respect to FIG. 6.

A request to generate training data for training a machine learning model is received at 202. In some embodiments, the request may be generated based on user input. For instance, a user may indicate a request to generate training data for a machine learning model. Alternatively, or additionally, the request may be generated automatically, for instance when a new structural equation is identified.

A structural equation for training data generation is identified at 204. According to various embodiments, a structural equation may be identified in any of various ways. For example, a user may manually specify a structural equation for generating data related to machine operation. As another example, such equations may be provided in a configuration file, along with supporting metadata information.

In particular embodiments, a structural equation may be used to model various types of operating conditions associated with a system. For example, one structural equation may model vibration data generated during normal operation of a machine, while another structural equation may model vibration data during a failure condition in which a bearing is failing due to a defect in an inner race. Each structural equation may include one or more variables, as well as metadata labeling the structural equation as corresponding to a particular mode of operation. The structural equation may be used to model, for example, vibration observable over time when a machine is operating in a particular failure condition.

In some embodiments, a structural equation may be generated based on empirical analysis, for instance in a laboratory environment. First, a machine may be operated in a stable state, while observing sensor data such as vibration data. Then, a defect may be introduced, such as a defect in a bearing ball or bearing race. The sensor data may continue to be observed as the machine or machine component operates and potentially fails as a consequence of the defect.

Simulated input data for the structural equation is determined at 206. According to various embodiments, the simulated input data may involve any data necessary for modeling the feature variables of interest in the structural equation. For example, the simulated input data may involve an amplitude value, which may vary over a particular range. As another example, a structural equation may include a time variable, as well as one or more other variables that vary as a function of time. In such a situation, the simulated input data may include a sequence of time values. As still another example, a structural equation may include a heat variable, as well as one or more other variables that vary as a function of heat. In such a situation, the simulated input data may include a sequence of heat values, for instance drawn from a range of heat values representative of real-world conditions. As yet another example, a structural equation may include multiple variables, in which case the simulated input data may include sequences of values generated in combination.

According to various embodiments, simulated input data may be generated in various ways. For example, simulated input data may be generated based at least in part on a sequence, such as a sequence of time. As another example, simulated input data may be generated based at least in part on a combinatorial process, for instance by combining different discrete values. As yet another example, simulated input data may be generated based at least in part on a statistical process, for instance by selecting random draws from a distribution.

A sampling frequency and a noise level for the structural equation are identified at 208. According to various embodiments, the sampling frequency and/or the noise level may be determined based on user input. Alternatively, or additionally, the sampling frequency and/or the noise level may be determined based at least in part on analysis of the structural equation.

In some embodiments, the sampling frequency and/or the noise level may be specified as constants. For instance, the sampling frequency may be specified in hertz, while the noise level may be specified as a standard deviation. Alternatively, or additionally, one or more of the sampling frequency or the noise level may be specified as a function that varies based on some input value. For instance, a structural equation may be sampled at a higher rate for some value ranges than for other value ranges.

Signal data is determined at 210 based on the simulated input data and the sampling frequency. In some embodiments, the signal data may be determined by applying the structural equation to the simulated input data and determining signal data at the specified sampling frequency.

According to various embodiments, the signal data may be represented as a set of observations. Each observation may include a feature vector that each includes values corresponding with one or more features. The features may be specified as, for instance, variables in the structural equation. In addition, the feature vectors may be labeled based on characteristics and/or metadata associated with the structural equation. For example, one structural equation may be known to model a particular failure condition, while another structural equation may be known to model a steady state of operation. As another example, one feature vector for a structural equation may be known to correspond to a particular failure condition, while another feature vector for a structural equation may be known to correspond to a steady state of operation. These known states may provide the labels for constructing the labeled feature vectors.

Noisy signal data is determined at 212 based on the signal data and the noise level. In some embodiments, determining the noisy signal data may involve applying a statistical simulation process in which new data is generated by combining randomly or pseudo-randomly generated noise with the signal data. For example, consider a signal data point indicating a particular vibration level value at a particular point in time. One or more noisy signal data points may be generated by selecting a random draw from a normal distribution having a mean at the signal data point and a standard deviation determined based on the noise level. As another example, other types of distributions may be used instead of a normal distribution.

Transformed data is determined at 214 based on the noisy signal data. In some embodiments, determining transformed data may involve applying one or more transformation functions to the noisy signal data. Depending on the context, any of a variety of transformation functions may be used.

In particular embodiments, a Fourier transformation may be applied to convert the noisy signal data to the frequency domain. The resulting transformed data may be on the power spectrum, in which signal power is determined as a function of frequency.

According to various embodiments, transformation may help to deal with cyclicity in the data. For instance, vibration data for a machine component may exhibit seasonal variation patterns that vary based on, for example, the particular stage of a mechanical process. Alternatively, or additionally, transformation may help to address issues related to analog-to-digital conversion, since sensors may differ in their sampling frequency.

A determination is made at 216 as to whether to identify an additional structural equation for generating training data. In some embodiments, additional structural equations may be identified and analyzed until a suitable terminating condition is met, such as analysis of all available structural equations having been completed.

When it is determined not to identify an additional structural equation for generating training data, at 218 training data is determined based on the transformed data. In some embodiments, the training data may be determined by combining the transformed data generated for different structural equations into a single data set.

The training data is stored at 220. In some embodiments, the training data may be stored in such a way that it may be used to train a supervised machine learning prediction model as discussed with respect to the method 300 shown in FIG. 3 and to train an unsupervised machine learning segmentation model as discussed with respect to the method 400 shown in FIG. 4. For example, the training data may be stored as a set of labeled feature vectors suitable for use in supervised machine learning analysis.

In particular embodiments, training data may include feature vectors and/or case attribute vectors. Case attribute vectors may include characteristics such as device specifications, physical attributes, operating conditions such as temperature or speed, or other such metadata values characterizing a training data observation. In some configurations, some or all of the case attribute data may be stored within the feature vector. Alternatively, or additionally, case attribute data may be stored separately, for instance in a case attribute vector.

According to various embodiments, one or more operations shown in FIG. 2 may be performed in an order different from that shown. For instance, one or more of operations 204-216 may be performed in parallel, for example to analyze more than one structural equation at the same time.

According to various embodiments, one or more operations shown in FIG. 2 may be omitted. For instance, in some contexts noisy signal data may be used directly without transforming it as discussed with respect to operation 214.

FIG. 3 illustrates an example of a method 300 for determining a supervised machine learning prediction model, performed in accordance with one or more embodiments. According to various embodiments, the method 300 may be performed on any suitable computing device, such as the system 600 discussed with respect to FIG. 6.

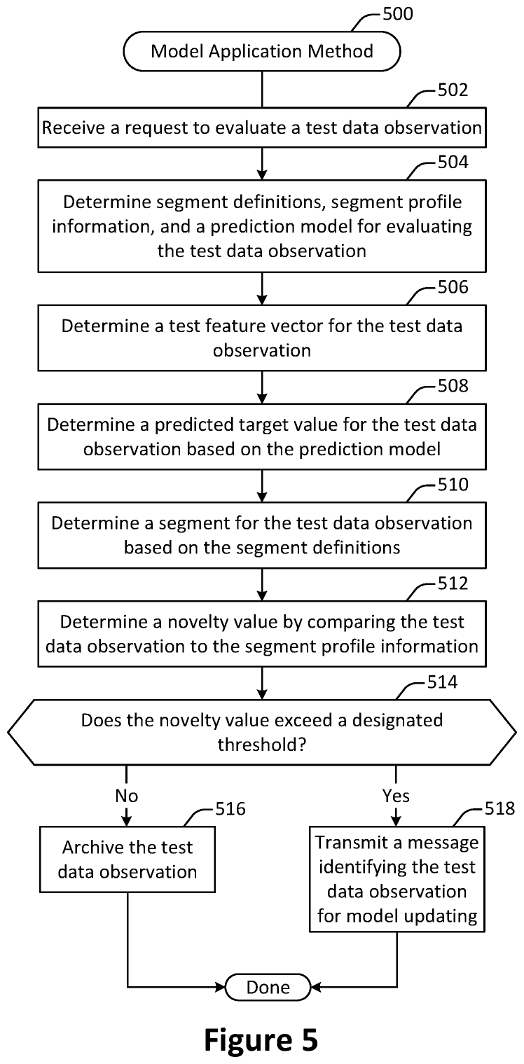

A request to determine a supervised machine learning prediction model for predicting a target variable is received at 302. In some embodiments, the request to determine the supervised machine learning prediction model may be generated based on user input. For instance, the supervised machine learning prediction model may be generated in order to create a model for deployment in a production process. Alternatively, the request to determine the supervised machine learning prediction model may be generated automatically. For instance, in a production context, the supervised machine learning prediction model may be updated based on novel data detected after the supervised machine learning prediction model has been deployed. Additional details regarding the detection and treatment of novel data are discussed with respect to the method 500 shown in FIG. 5.

Training data is determined at 304. In some embodiments, the training data may be determined as discussed with respect to the method 200 shown in FIG. 2. Alternatively, or additionally, some or all of the training data may be pre-determined in some other manner, for instance based on data empirically observed in a real-world or laboratory environment. As yet another possibility, some or all of the training data may be novel data determined as discussed with respect to the method 500 shown in FIG. 5.

A supervised machine learning model is determined based on the training data at 306. According to various embodiments, any of a variety of supervised machine learning models may be employed depending on the context. Such models may include, but are not limited to: tree-based models (e.g., random forests), neural network models (e.g., deep learning models), regression models (e.g., logit models), and ensemble models. The particular operations employed for determining the trained supervised machine learning model may vary based on the type of model employed.

A determination is made at 308 as to whether to update the supervised machine learning model. According to various embodiments, the determination may involve validating the supervised machine learning prediction model using validation data. For instance, the system may determine whether the performance of the supervised machine learning prediction model in predicting the validation data exceeds a designated threshold.

The supervised machine learning model is stored at 310. In some embodiments, storing the supervised machine learning model may involve deploying the supervised machine learning model in a production environment. For example, the supervised machine learning model may be deployed in conjunction with one or more physical sensors in a hardware context. However, a variety of storage and deployment contexts are possible.

FIG. 4 illustrates an example of a method 400 for determining an unsupervised machine learning segmentation model, performed in accordance with one or more embodiments. According to various embodiments, the method 400 may be performed on any suitable computing device, such as the system 600 discussed with respect to FIG. 6.

A request to determine an unsupervised machine learning segmentation model is received at 402. According to various embodiments, the request may be generated as discussed with respect to the operation 106 shown in FIG. 1.

Training data is determined at 404. In some embodiments, the training data may be determined as discussed with respect to the method 200 shown in FIG. 2. Alternatively, or additionally, some or all of the training data may be pre-determined in some other manner, for instance based on data empirically observed in a real-world or laboratory environment. As yet another possibility, some or all of the training data may be novel data used to update the model determined as discussed with respect to the method 500 shown in FIG. 5. The training data determined at 404 may be substantially similar to or identical with the training data determined at 304.

A plurality of data segments are determined at 406 using an unsupervised machine learning segmentation model. According to various embodiments, any of a variety of segmentation models may be used. Such models may include, but are not limited to: k-means clustering, mean-shift clustering, density-based spatial clustering of applications with noise (DBSCAN), expectation-maximization (EM) clustering using Gaussian mixture models (GMM), and combinations models. The particular operations performed to determine the plurality of data segments may depend in part on the type of segmentation model employed.

In some embodiments, the plurality of data segments may be determined by maximizing the distance between data segments in different feature vectors while minimizing the distance between feature vectors within the same data segment. In some configurations, the data segments may be constructed so that they do not overlap. That is, a feature vector may belong to only one data segment.

A respective segment definition is determined for each of the segments at 408. According to various embodiments, the segment definition for a segment may include one or more criteria used to identify a feature vector as belonging to the segment. For instance, the segment definition may define a region in a feature spaced. A region within a feature space may be defined based on characteristics such as one or more ranges of feature values, one or more distances from a central point or points, one or more functions over feature values, one or more boundary points, or any other suitable mechanism for delineation. The segment definition may also include other related information, such as a number of feature vectors in the training data that fall within the segment definition.

A respective segment profile is determined for each of the segments at 410. According to various embodiments, the segment profile for a segment may be determined by performing a statistical analysis of the feature vectors classified as belonging to the segment under the segment definition determined at 408. Depending on the context, any of various types of statistical analysis may be performed. Some examples of such analysis include statistics such as the mean, median, maximum, minimum, standard deviation, variance, skewness, kurtosis, or one or more percentiles of one or more features represented in the feature vectors, and/or a number of feature vectors in the training data that fall within the segment definition. Other examples of such analysis include identification of characteristics such as a distributional form (e.g., a normal distribution) for one or more features represented in the feature vectors.

Segment information is stored at 412. According to various embodiments, the segment information that is stored may include the segment definitions identified at 408 and the segment profiles identified at 410. The segment information may be stored in such a way that it may be deployed with a prediction model to for application to test data, as discussed in additional detail with respect to the method 500 shown in FIG. 5.

FIG. 5 illustrates an example of a method 500 for applying supervised and unsupervised models, performed in accordance with one or more embodiments. According to various embodiments, the method 500 may be performed on any suitable computing device, such as the system 600 discussed with respect to FIG. 6.

A request to evaluate a test data observation is received at 502. In some implementations, the request may be received at a computing device analyzing sensor data for a deployed prediction model. For instance, the request may be received at a computing device configured to monitor sensor data for one or more machines deployed in a machine shop.

According to various embodiments, the method 500 is described for the purpose of exposition as being used to evaluate a single test data observation. However, the techniques described with respect to the method 500 shown in FIG. 5 may be applied to any suitable number of test data observations, analyzed in sequence or in parallel.

Segment definitions, segment profile information, and a prediction model for evaluating the test data are determined at 504. In some implementations, the segment definitions, segment profile information, and a prediction model may be determined as discussed with respect to the methods 300 and 400 shown in FIG. 3 and FIG. 4.

A test data observation is determined for the test data at 506. In some embodiments, the test data observation may be determined by applying to the test data the same one or more transformations discussed with respect to the operation 214 shown in FIG. 2.

At 508, a predicted target value is determined for the test data observation based on the prediction model. According to various embodiments, the predicted target value may be determined by applying the pre-trained prediction model to the test data observation to produce the predicted target value.

A segment for the test data observation is determined at 510 based on the segment definitions. In some embodiments, as discussed with respect to the method 400 shown in FIG. 4, the training data may be divided into multiple segments, each of which is associated with a respective segment definition. A segment definition may include, for instance, a set of boundary conditions that identify an area of the feature space. The segment for the test data observation may be determined by comparing it to the boundary conditions for the different segments and then categorizing it as belonging to a designated one of the segments.

According to various embodiments, in the event that the test data observation does not meet the definition for any of the segments, then the test data observation may be assigned to the segment to which it is most proximate. Distance from the test data observation to the segment may be defined in any of various ways. For example, distance may be measured to the center or to the boundary of the segment. As another example, a statistical metric may be used, such as the number of standard deviations of the distance metric from the center of the segment to the test data observation. The standard deviation may be defined, for instance, based on an application of the distance metric to the training data observations included in the segment.

A novelty value is determined at 512 by comparing the test data observation to the segment profile information. According to various embodiments, the novelty value may be determined by calculating a normalized distance from the test data observation to the center of the segment profile. For example, a distance of test data observation to the center of the segment profile may be divided by the standard deviation of such distances for training data observations in the segment to produce the novelty value.

A determination is made at 514 as to whether the novelty value exceeds a designated threshold. According to various embodiments, the designated threshold may be strategically determined based on various considerations. For instance, a higher threshold may result in less model adjustment, which may yield less precise models while saving computational resources. On the other hand, a lower threshold may result in more model adjustment, which may yield more precise models at the expense of increased computational resources.

If it is determined that the novelty value does not exceed the designated threshold, then at 516 the test data observation is archived. According to various embodiments, archiving the test data observation may involve storing the test data observation for later use. For example, the test data observation may be used in subsequent model training. As another example, the test data observation may be manually reviewed by an administrator, who may take an action such as discarding the test data observation, manually labeling the test data observation, and/or using the test data observation for model training.

According to various embodiments, more than one novelty value threshold may be used to evaluate the test data. For example, two different novelty value thresholds may be used to categorize a designated test data observation as being either well-represented, under-represented, or mis-represented in the training data used to train the model.

If it is instead determined that the novelty value does not exceed the designated threshold, then at 518 a message identifying the test data observation for model updating is transmitted. According to various embodiments, the message may be transmitted via a communication interface. The message may cause one or more of the operations shown in FIG. 3 and/or FIG. 4 to be performed again, with previously-employed training data supplemented by observed test data. In some configurations, previously-employed training data may eventually be replaced with observed test data, for instance over the long term if sufficient test data is available.

In some embodiments, the message may be transmitted to a user via a user interface. The user may then view information related to the novelty determination. In some configurations, the user interface may be operable to receive user input. The user input may indicate, for instance, whether the model should be updated.

According to various embodiments, the method 500 is described as creating and evaluating a single novelty value for a single test data observation, for the purpose of exposition. However, the method 500 may be used to test more than one test observation. Alternatively, or additionally, the method 500 may be used to create and evaluate more than one novelty value for each test observation. For example, as described herein, the method 500 may be used to separately or jointly evaluate the novelty of a feature vector and a case attribute vector for a test observation. In such a configuration, a test data observation may be treated as novel if either the novelty of the case attribute vector or the feature vector exceeds a respective novelty threshold.

FIG. 6 illustrates one example of a computing device. According to various embodiments, a system 600 suitable for implementing embodiments described herein includes a processor 601, a memory module 603, a storage device 605, an interface 611, and a bus 615 (e.g., a PCI bus or other interconnection fabric.) System 600 may operate as variety of devices such as a computing device in a model training context, a computing device in a deployed model test context, or any other device or service described herein. Although a particular configuration is described, a variety of alternative configurations are possible. The processor 601 may perform operations such as implementing a prediction model, performing drift detection, and/or updating a prediction model. Instructions for performing such operations may be embodied in the memory 603, on one or more non-transitory computer readable media, or on some other storage device. Various specially configured devices can also be used in place of or in addition to the processor 601. The interface 611 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user. In some embodiments, the computing device 600 may be implemented in a cloud computing environment.

Any of the disclosed implementations may be embodied in various types of hardware, software, firmware, computer readable media, and combinations thereof. For example, some techniques disclosed herein may be implemented, at least in part, by computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Java, Python, C++, C, HTML, any other markup language, JavaScript, ActiveX, VBScript, or Perl. Examples of computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. Particular embodiments may be implemented without some or all of the specific details described herein. In other instances, well known process operations have not been described in detail in order to avoid unnecessarily obscuring the disclosed techniques. Accordingly, the breadth and scope of the present application should not be limited by any of the implementations described herein, but should be defined only in accordance with the claims and their equivalents.

1. A method comprising:
determining via a processor a plurality of input data signal values by sampling at a designated sampling frequency from a designated structural equation modeling a mechanical process over time during one or more states of a plurality of states of the mechanical process;
determining via the processor a plurality of noise values by applying a noise generator to the input data signal values based on a designated noise level;
determining via the processor a plurality of simulated noisy data signal values corresponding to one or more observable properties of the mechanical process by combining the plurality of input data signal values with the plurality of noise values;
determining a prediction model, via a processor, based on a plurality of training data observations including: (1) the simulated noisy data signal values corresponding to one or more observable attributes of the mechanical process and (2) the one or more states of the plurality of states of the mechanical process;
determining a test data observation including a plurality of feature values corresponding to the observable attributes of the mechanical process by recording data from a plurality of physical sensors observing one or more components of the mechanical process over time;
determining via a processor a predicted state of the plurality of states for the test data observation based on the prediction model, the predicted state indicating a failure condition of one or more of the mechanical component; and
storing the predicted state and the prediction model on a storage device.

2. The method recited in claim 1, wherein the designated structural equation is one of a plurality of structural equations, and wherein the plurality of input data signal values are determined by sampling from the plurality of structural equations.

3. The method recited in claim 1, the method further comprising:
determining input data for the designated structural equation, the input data including one or more parameter values corresponding with parameters in the designated structural equation.

4. The method recited in claim 3, wherein a designated one of the parameter values corresponds to a physical characteristic of a mechanical machine associated with the physical process.

5. The method recited in claim 1, wherein the physical process includes operation of a mechanical bearing type, and wherein the plurality of states include a designated state corresponding with a failure mode associated with the mechanical bearing type.

6. The method recited in claim 1, wherein the test data observation includes a feature vector including a plurality of values corresponding with the plurality of input data signal values.

7. The method recited in claim 1, the method further comprising:
determining a predicted target value by applying the prediction model to the test data observation.

8. The method recited in claim 7, the method further comprising:
determining a designated feature data segment of a plurality of feature data segments by applying a feature segmentation model to a test data observation, the feature segmentation model being pre-trained via the noisy data signal values and the one or more states, the feature segmentation model dividing the plurality of training data observations into the plurality of feature data segments.

9. The method recited in claim 8, the method further comprising:
determining a feature novelty value based at least in part on the predicted target value and the test data observation, the feature novelty value indicating a degree to which the test data observation is represented in the training data observations.

10. The method recited in claim 7, wherein the test data observation includes a case attribute vector, the case attribute vector including one or more metadata values characterizing the test data observation, wherein the processor is further operable to determine a designated case attribute data segment of a plurality of case attribute data segments by applying a case attribute segmentation model to the case attribute vector via the processor, the case attribute segmentation model being pre-trained via the plurality of training data observations, the case attribute segmentation model dividing the plurality of training data observations into the plurality of case attribute data segments.

11. A system comprising:
a processor operable to:
determining a plurality of input data signal values by sampling at a designated sampling frequency from a designated structural equation modeling a mechanical process over time during one or more states of a plurality of states of the mechanical process;
determining a plurality of noise values by applying a noise generator to the input data signal values based on a designated noise level;
determining a plurality of simulated noisy data signal values corresponding to one or more observable properties of the mechanical process by combining the plurality of input data signal values with the plurality of noise values;
determine a prediction model based on a plurality of training data observations including: (1) the simulated noisy data signal values corresponding to one or more observable attributes of the mechanical process and (2) the one or more states of the plurality of states of the mechanical process;
determine a test data observation including a plurality of feature values corresponding to the observable attributes of the mechanical process by recording data from a plurality of physical sensors observing one or more components of the mechanical process over time;
determine a predicted state of the plurality of states for the test data observation based on the prediction model, the predicted state indicating a failure condition of one or more of the mechanical component; and
a storage device operable to store the predicted state and the prediction model.

12. The system recited in claim 11, wherein the designated structural equation is one of a plurality of structural equations, and wherein the plurality of input data signal values are determined by sampling from the plurality of structural equations.

13. The system recited in claim 11, wherein the processor is further operable to:
determine input data for the designated structural equation, the input data including one or more parameter values corresponding with parameters in the designated structural equation, wherein a designated one of the parameter values corresponds to a physical characteristic of a mechanical machine associated with the physical process.

14. The system recited in claim 11, wherein the physical process includes operation of a mechanical bearing type, and wherein the plurality of states include a designated state corresponding with a failure mode associated with the mechanical bearing type.

15. The system recited in claim 11, wherein the test data observation includes a feature vector including a plurality of values corresponding with the plurality of input data signal values.

16. The system recited in claim 11, wherein the processor is further operable to:
determine a predicted target value by applying the prediction model to the test data observation;
determine a designated feature data segment of a plurality of feature data segments by applying a feature segmentation model to a test data observation, the feature segmentation model being pre-trained via the noisy data signal values and the one or more states, the feature segmentation model dividing the plurality of training data observations into the plurality of feature data segments; and
determine a feature novelty value based at least in part on the predicted target value and the test data observation, the feature novelty value indicating a degree to which the test data observation is represented in the training data observations.

17. One or more non-transitory computer readable media having instructions stored thereon for performing a method, the method comprising:
determining via a processor a plurality of input data signal values by sampling at a designated sampling frequency from a designated structural equation modeling a mechanical process over time during one or more states of a plurality of states of the mechanical process;
determining via the processor a plurality of noise values by applying a noise generator to the input data signal values based on a designated noise level;
determining via the processor a plurality of simulated noisy data signal values corresponding to one or more observable properties of the mechanical process by combining the plurality of input data signal values with the plurality of noise values;
determining a prediction model, via a processor, based on a plurality of training data observations including: (1) the simulated noisy data signal values corresponding to one or more observable attributes of the mechanical process and (2) the one or more states of the plurality of states of the mechanical process;
determining a test data observation including a plurality of feature values corresponding to the observable attributes of the mechanical process by recording data from a plurality of physical sensors observing one or more components of the mechanical process over time;
determining via a processor a predicted state of the plurality of states for the test data observation based on the prediction model, the predicted state indicating a failure condition of one or more of the mechanical component; and
storing the predicted state and the prediction model on a storage device.

18. The one or more non-transitory computer readable media recited in claim 17, the method further comprising:
determining input data for the designated structural equation, the input data including one or more parameter values corresponding with parameters in the designated structural equation, wherein a designated one of the parameter values corresponds to a physical characteristic of a mechanical machine associated with the physical process.

19. The one or more non-transitory computer readable media recited in claim 17, wherein the test data observation includes a feature vector including a plurality of values corresponding with the plurality of input data signal values.

20. The one or more non-transitory computer readable media recited in claim 17, the method further comprising:
determining a predicted target value by applying the prediction model to the test data observation;
determining a designated feature data segment of a plurality of feature data segments by applying a feature segmentation model to a test data observation, the feature segmentation model being pre-trained via the noisy data signal values and the one or more states, the feature segmentation model dividing the plurality of training data observations into the plurality of feature data segments; and
determining a feature novelty value based at least in part on the predicted target value and the test data observation, the feature novelty value indicating a degree to which the test data observation is represented in the training data observations.
